(19) United States
(12) Patent Application Publication
(10) Pub. No.: US 2025/0244972 A1
(43) Pub. Date: Jul. 31, 2025

(54) Generating Graphical User Interfaces from Design Specifications and Design Specifications from Graphical User Interfaces

(71) Applicant: ServiceNow, Inc., Santa Clara, CA (US)

(72) Inventors: Chaitanya Saragadam, Hyderabad (IN); Avishek Dalal, Hyderabad (IN); Suhas K. S., Bangalore (IN); Gaurav Goyal, Santa Clara, CA (US)

(21) Appl. No.: 18/425,491

(22) Filed: Jan. 29, 2024

(51) Int. Cl. G06F 8/38; G06F 8/10; G06F 40/40

(52) U.S. Cl. CPC G06F 8/38; G06F 8/10; G06F 40/40

(57) ABSTRACT

Example embodiments may include: obtaining a design specification of a graphical user interface (GUI), wherein the design specification is compatible with a GUI design tool and includes a layout of design artifacts; generating, through use of a component mapper, respectively corresponding GUI components for the design artifacts in accordance with the layout; populating, based on properties of the design artifacts, respectively corresponding properties of the GUI components; and generating, based on the layout, the GUI components, and their corresponding properties, a deployable software implementation of the GUI.

### BACKGROUND

Graphical user interface (GUI) design tools are software applications used for creating, prototyping, and collaborating on user interface designs for websites, standalone applications, dedicated client applications, and mobile applications. These tools provide a suite of features that allow creation of detailed and interactive visual representations of GUIs. Such features may include placement and graphical editing of design artifacts (e.g., panels, buttons, menus, and other visual elements), alignment mechanisms for arranging these and other design artifacts, interactive prototyping and collaboration, and so on.

A GUI design from such a tool may be used as a basis to implement a GUI in software. This involves development of code to implement the GUI design within various programming languages, such as a web-based framework using a combination of JavaScript, HyperText Markup Language (HTML), and Cascading Style Sheets (CSS). Thus, the GUI design can be employed as a guiding principle in code development, but the GUI software implementation is developed independently.

Furthermore, the GUI design and implementation phases can be iterative. Thus, the GUI design may change during GUI software implementation, causing the two to become unsynchronized. However, there is currently no way to consistently and accurately update the GUI software implementation based on the GUI design or vice versa in a computationally efficient fashion.

### SUMMARY

Various examples disclosed herein include techniques that enable programmatically converting a GUI design specification generated by a GUI design tool into a GUI software implementation. Other disclosed techniques enable programmatically converting a GUI software implementation into a GUI design specification that can be imported into a GUI design tool. These procedures are respectively referred to herein as “design-to-GUI” and “GUI-to-design”. With these techniques, GUI software implementations can be developed, updated, and maintained in a faster and more computationally efficient fashion while retaining synchronization with their respective GUI design specifications.

For example, a GUI design specification can be represented in a structured format (e.g., metadata in a text file) that provides an arrangement of design artifacts that are used as elements of the GUI design (e.g., panels, buttons, menus, and other visual elements). Such a GUI design specification may be converted into an implementation-neutral design format by using component mappings (e.g., predefined associations between design artifacts and GUI components) and possibly natural language processing. The implementation-neutral design format can be parsed and converted on a component-by-component basis into a GUI software implementation (e.g., a combination of JavaScript, HTML, and CSS).

Conversely, such a GUI software implementation can be converted into an implementation-neutral design format (which may be the same or a different format as the implementation-neutral design format used with the design-to-GUI procedure). This conversion may also take place on a component-by-component basis. The implementation-neutral format may be further converted into a GUI design specification by using reverse component mappings.

Accordingly, a first example embodiment may involve obtaining a design specification of a GUI, wherein the design specification is compatible with a GUI design tool and includes a layout of design artifacts; generating, through use of a component mapper, respectively corresponding GUI components for the design artifacts in accordance with the layout; populating, based on properties of the design artifacts, respectively corresponding properties of the GUI components; and generating, based on the layout, the GUI components, and their corresponding properties, a deployable software implementation of the GUI.

A second example embodiment may involve obtaining a deployable software implementation of a GUI, wherein the deployable software implementation is compatible with a GUI framework and includes a layout of GUI components; generating, through use of a reverse component mapper, respectively corresponding design artifacts for the GUI components in accordance with the layout; populating, based on properties of the GUI components, respectively corresponding properties of the design artifacts; and generating, based on the layout, the design artifacts, and their corresponding properties, a design specification of the GUI that is compatible with a GUI design tool.

A third example embodiment may involve a non-transitory computer-readable medium, having stored thereon program instructions that, upon execution by a computing system, cause the computing system to perform operations in accordance with any of the previous example embodiments.

In a fourth example embodiment, a computing system may include at least one processor, as well as memory and program instructions. The program instructions may be stored in the memory, and upon execution by the at least one processor, cause the computing system to perform operations in accordance with any of the previous example embodiments.

In a fifth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an overall architecture for a design-to-GUI process, in accordance with example embodiments.

FIG. 7 depicts a large language model (LLM) service, in accordance with example embodiments.

FIG. 8 depicts component mapper, in accordance with example embodiments.

FIG. 9A depicts a content tree generator, in accordance with example embodiments.

FIGS. 9B, 9C, 9D, 9E, and 9F depict JSON structures and mappings used in conjunction with a content tree generator, in accordance with example embodiments.

FIG. 10A depicts a converter, in accordance with example embodiments.

FIG. 10B depicts JSON structures used with converting a GUI design to a GUI software implementation, in accordance with example embodiments.

FIG. 11 depicts an overall architecture for a GUI-to-design process, in accordance with example embodiments.

FIG. 12 depicts a reverse component mapper, in accordance with example embodiments.

FIGS. 13A, 13B, 13C, 14A, and 14B depict JSON structures and mappings used in conjunction with the GUI-to-design process, in accordance with example embodiments.

FIG. 15 is a flow chart, in accordance with example embodiments.

FIG. 16 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

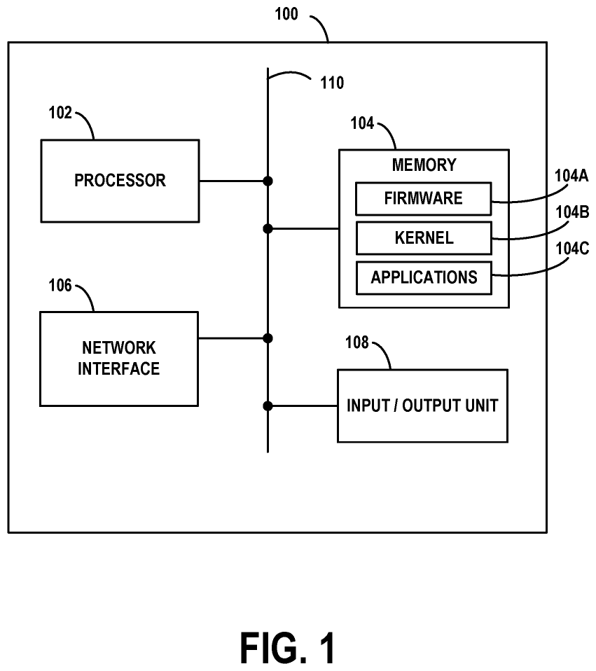

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

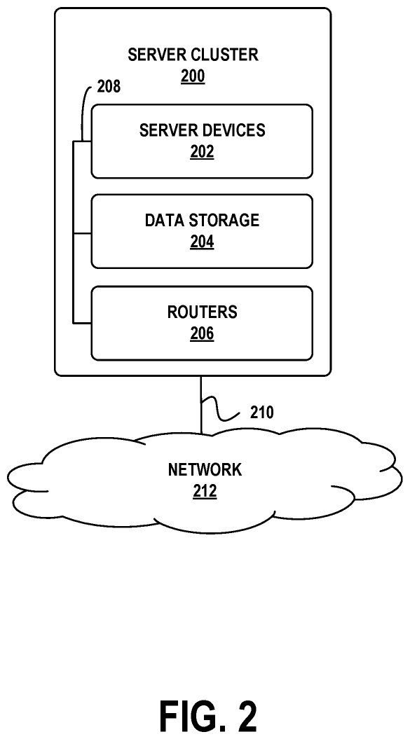

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

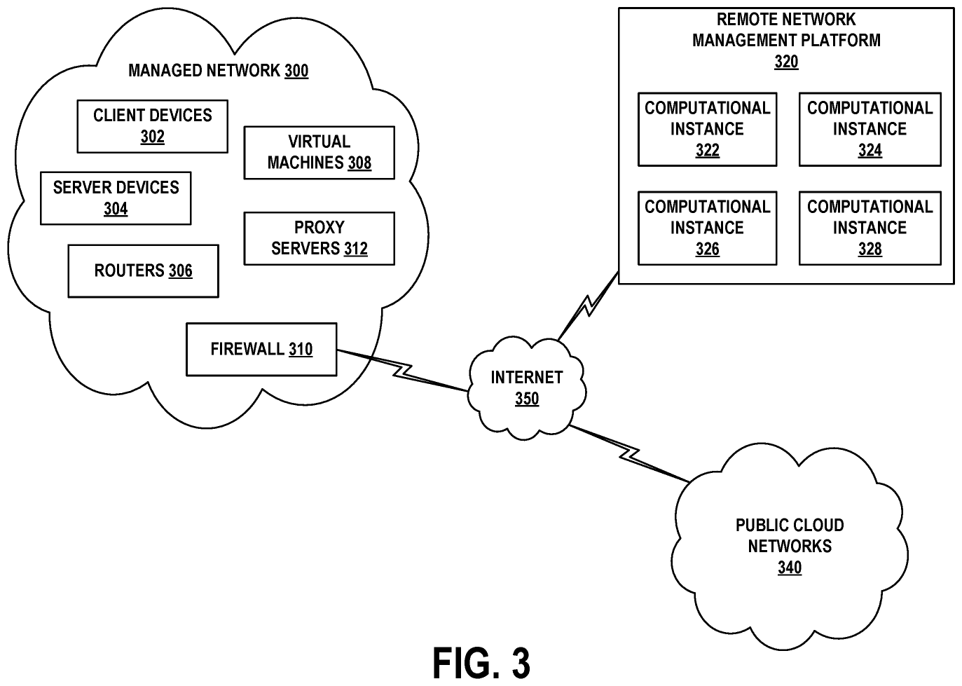

FIG. 3 depicts a remote network management architecture, in accordance with example embodiments. This architecture includes three main components-managed network 300, remote network management platform 320, and public cloud networks 340-all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

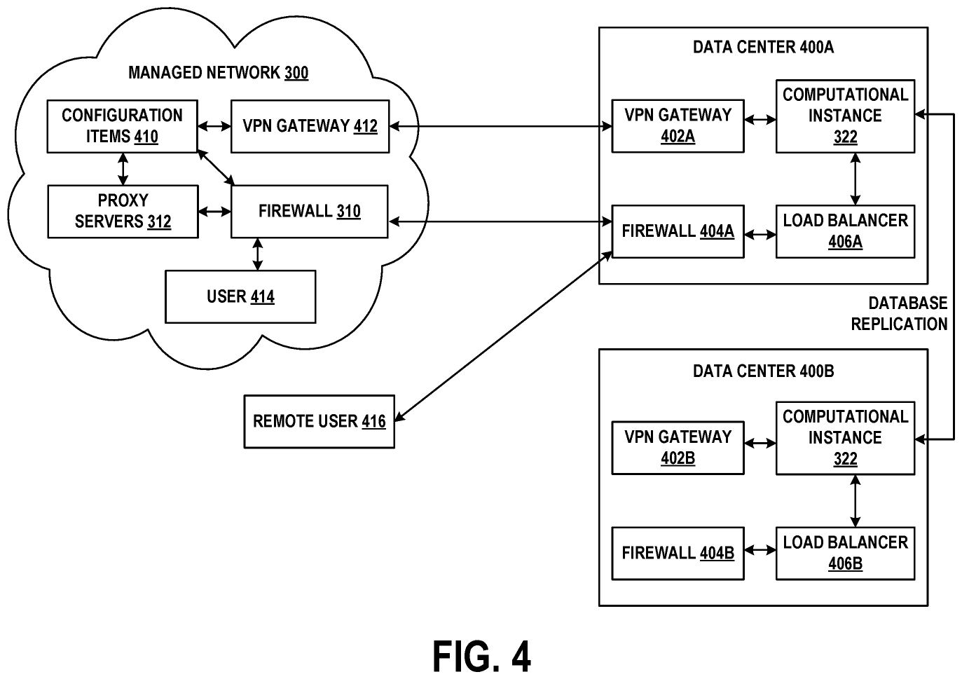

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

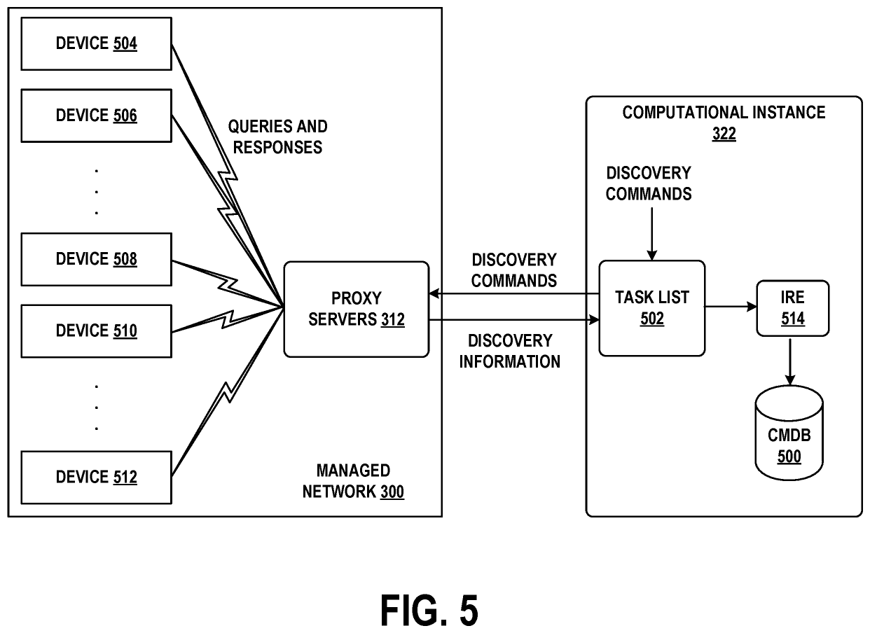

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices-for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Graphical User Interfaces and Components

Graphical user interfaces (GUIs) consist of one or more screens, with each screen including a set of GUI components. Such GUI components may include buttons, non-editable text labels, text boxes (e.g., for text entry by a user), check boxes, radio buttons, drop-down menus or lists, list boxes with selectable list items, sliders, charts, graphs, panels (sections of an interface that may contain other GUI components), progress indicators (e.g., progress bars), menu bars, tool bars, tabbed controls, dialog boxes, scroll bars, image viewers (e.g., a container to display an image or icon), tooltips (e.g., a pop-up box that provides context information when hovered over or actuated), separators, and so on. Some GUI components may serve as containers for other GUI components (e.g., panels as noted above or list boxes containing list items).

This list of GUI components is not comprehensive. More or fewer types of GUI components may be used in various GUIs. Further, different names may be used to refer to certain GUI components (e.g., a panel may also be called a pane, a container, a frame, or a box).

Each of these GUI components may have a number of properties, including one or more of each of: a size (e.g., dimensions in pixels, inches, or centimeters), a position (e.g., defined by the top left corner of the GUI component in either relative or absolute coordinates), a color (e.g., a background color, a foreground color, and/or a text color), a style (e.g., a font, font size, and/or line weight), a visibility (e.g., shown or hidden), a validation rule (e.g., for text entry), a reference to a data binding (e.g., units of data in a data model that the GUI component can display and/or update), and/or a custom event handling routine or script. Other GUI components may have additional properties that are hard-coded or configurable.

When arranged to be rendered for display on a GUI, these GUI components inherently exhibit a hierarchical structure. For example, the hierarchy may be tree-like, with the screen itself being the root node of the tree and the GUI components being arranged as children of the root node or of other GUI components. Such a tree-like hierarchy can be helpful when representing the GUI components in a data structure, as the data structure encodes the visual layout of the GUI components with respect to one another.

In general, a GUI component is a reusable and modular element that can be embedded into a web-based interface or custom application. It is typically defined using web technologies such as JavaScript, HTML, and CSS within a web-based framework. But other GUI frameworks, such as ANGULAR® or REACT® may be used. ANGULAR®, for example, allows GUI component appearance, data bindings, and behaviors to be specified in an object-oriented programming language. REACT® uses a combination of JavaScript and HTML to achieve a similar goal.

GUI components provide a way to encapsulate and package functionality, making it easier to build and maintain complex interfaces. In addition to being reusable (thus promoting interface consistency and development efficiency), GUI components can be customized and interactively respond to actions or events.

### VII. Example Design-to-GUI Procedures

Software applications known as GUI design tools are employed in development, prototyping, and collaboration with respect to GUI designs pertinent to various platforms, including websites, standalone applications, client-specific applications, and mobile applications. These GUI design tools encompass an array of features designed to facilitate the crafting of intricate and dynamic GUI design specifications. Among the features offered are design artifacts such as buttons, non-editable text labels, text boxes, check boxes, radio buttons, drop-down menus or lists, list boxes with selectable list items, sliders, charts, graphs, panels, progress indicators, menu bars, tool bars, tabbed controls, dialog boxes, scroll bars, image viewers, tooltips, separators, and so on. GUI design tools may also facilitate the arrangement of such GUI components relating to one another (e.g., a GUI layout).

Notably, design artifacts are inherently analogous to GUI components, though different naming conventions may be used for each. Also like GUI components, design artifacts can be arranged in a tree-like, hierarchical fashion with some design artifacts (e.g., panels) serving as containers for other design artifacts.

Other GUI design tool features may include graphical editing capabilities for the formation of shapes, icons, and visual elements, and alignment tools for the organization of the design artifacts. Additionally, these GUI design tools enable interactive prototyping and collaborative efforts. Subsequent to the design phase, software engineers utilize the resulting GUI design specifications as foundations for implementing GUIs in software.

Examples of GUI design tools include one or more of FIGMAR, INVISION®, MIRO®, and various ADOBE® software packages. But other possibilities exist. Each of these GUI design tools may be capable of representing a GUI design specification in the tool's own particular manner. For example, FIGMA® represents a GUI design specification as a set of frames (containers) representing screens or pages. These frames may nested within one another in a hierarchical, tree-like manner. Design artifacts may be placed within frames. Each design artifact may be assigned various properties, such as sizes, colors, text fonts, and other effects. GUI design tools may allow a GUI design specification to be stored as metadata in a proprietary format or exported to a known structured data format (e.g., XML or JSON).

Notably, the metadata within a GUI design specification typically include an arrangement of references to the design artifacts therein rather than a visual representation of each design artifact. An example of such a reference for a text box design artifact might specify the text box's properties (e.g., dimensions in pixels, offset, background color, text color, text font, and text size). The arrangement of these references may inherently specify their relations to one another (e.g., parent-child or sibling) in a tree-like layout. For example, in the metadata for a GUI design specification, a child design artifact may be nested within its parent design artifact.

Despite the availability of such GUI design tools, the process of developing a GUI software implementation from a GUI design specification remains a complex endeavor. Software engineers typically obtain access to the GUI design specification and use it within the GUI design tool as a visual guide for implementing the GUI in software code. This code could be in various GUI frameworks, such as JavaScript/HTML/CSS, ANGULAR®, or REACT® as some examples. The implementation process can take days or weeks, and may deviate to some extent from the intent of the designers. Therefore, it would be advantageous to have a programmatic way of converting a design specification into a GUI software implementation or at least a prototype thereof.

The embodiments herein provide a solution to this and possibly other technical problems. These embodiments are based on the observation that there can be a one-to-one mapping established between (i) each design artifact of a GUI design specification from a GUI design tool, and (ii) a GUI component that can be placed within a GUI software implementation. There also can be more involved mapping techniques to convert the properties of design artifacts into properties of GUI components. Nonetheless, doing so programmatically allows a GUI software implementation to be generated from GUI design specification with little or no additional coding from software engineers. Thus, GUI software implementations can be rapidly and accurately prototyped and developed in a computationally efficient fashion.

### A. Overall Architecture

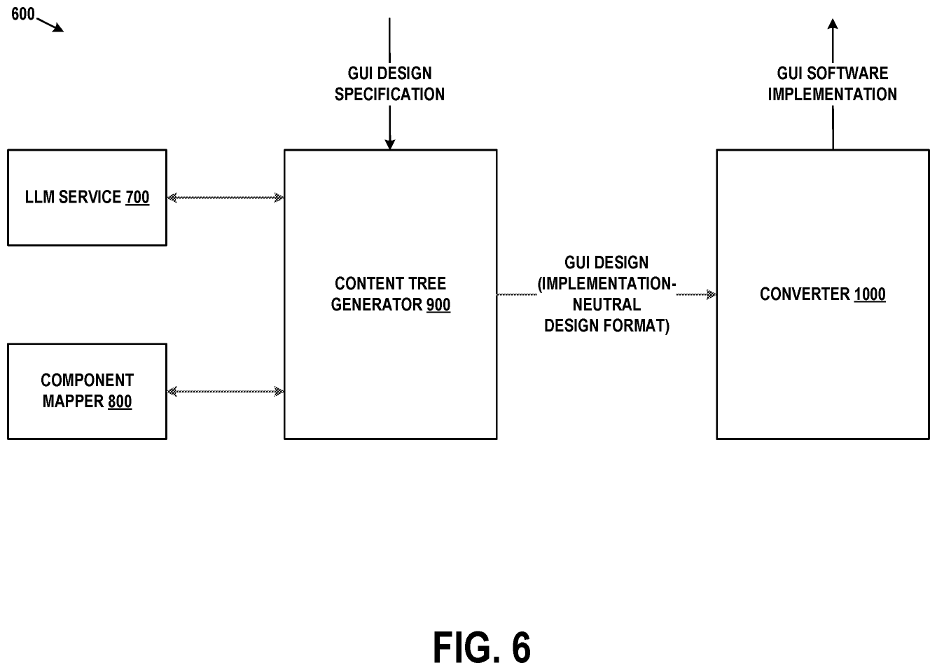

FIG. 6 depicts an overall architecture 600 for the design-to-GUI process. Overall architecture 600 includes software modules for large language model (LLM) service 700, component mapper 800, content tree generator 900, and converter 1000. Nonetheless, more or fewer parts of overall architecture 600 may be present. Notably, overall architecture 600 supports multiple instances of content tree generator 900, each configured to generate a GUI representation in an implementation-neutral design format from a different type of GUI design specification that was produced by a different GUI design tool. Overall architecture 600 also supports multiple instances of converter 1000, each configured to generate a different implementation-specific design format.

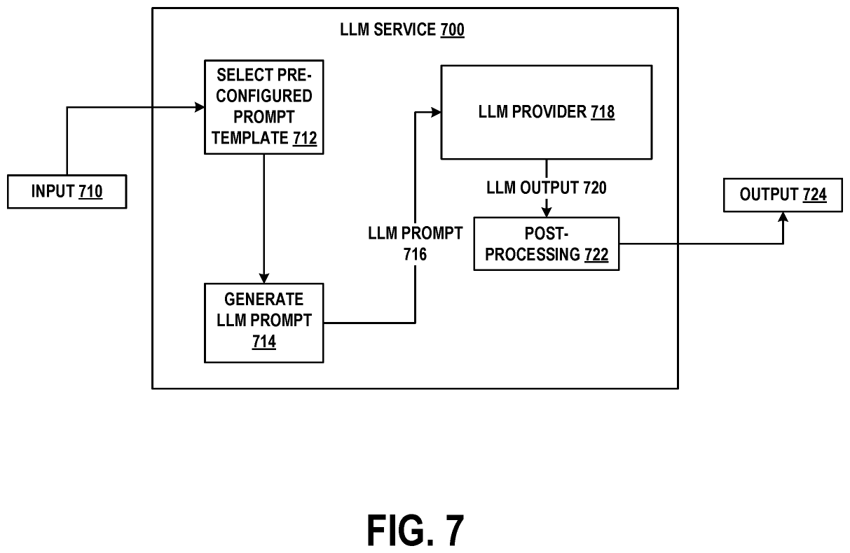

LLM service 700 may be configured to receive a prompt and use this prompt as the basis for a query to an LLM. The prompt may undergo pre-processing before it is submitted to the LLM in the form of the query, and the output provided by the LLM may undergo post-processing before it is returned as a reply to the prompt. Thus, LLM service 700 can be thought of as a “wrapper” or set of APIs around an LLM. While LLM service 700 may support text-based prompting and return text-based replies, it could be multimodal and thus also support non-text input and output. LLM service 700 will be described in more detail in the discussion of FIG. 7. For now, it can be assumed that LLM service 700 can receive prompts requesting it to produce content and LLM service 700 will produce the requested content.

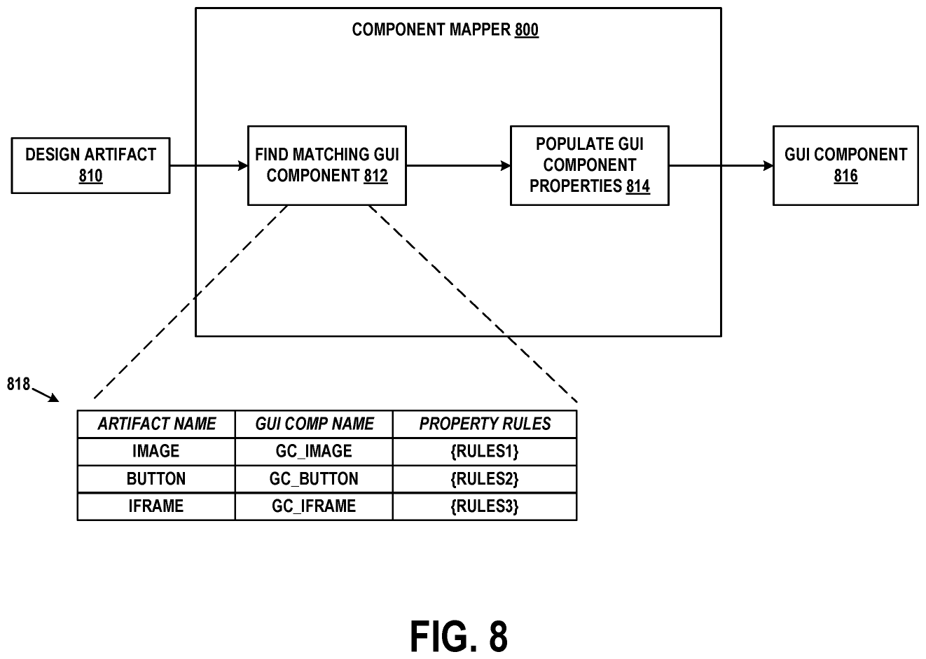

Component mapper 800 may include a set of associations (e.g., in the form of a table, hash map, or database) between representations of design artifacts and GUI components. The design artifacts may be those supported by a GUI design tool, and the components may be equivalent or similar GUI components supported by the implementation-neutral design format. Given a representation of a design artifact (e.g., a name or identifier thereof), component mapper 800 can return a representation of an equivalent or similar GUI component (e.g., a name or identifier thereof). The returned representation of the GUI component may include indications of the GUI component's properties (e.g., size, color, position, text font). These properties may be similar or the same to those the associated design artifact. Component mapper 800 will be described in more detail in the discussion of FIG. 8.

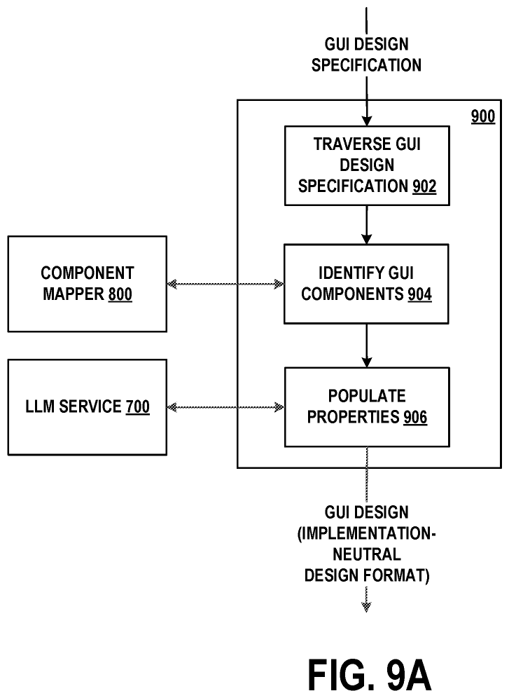

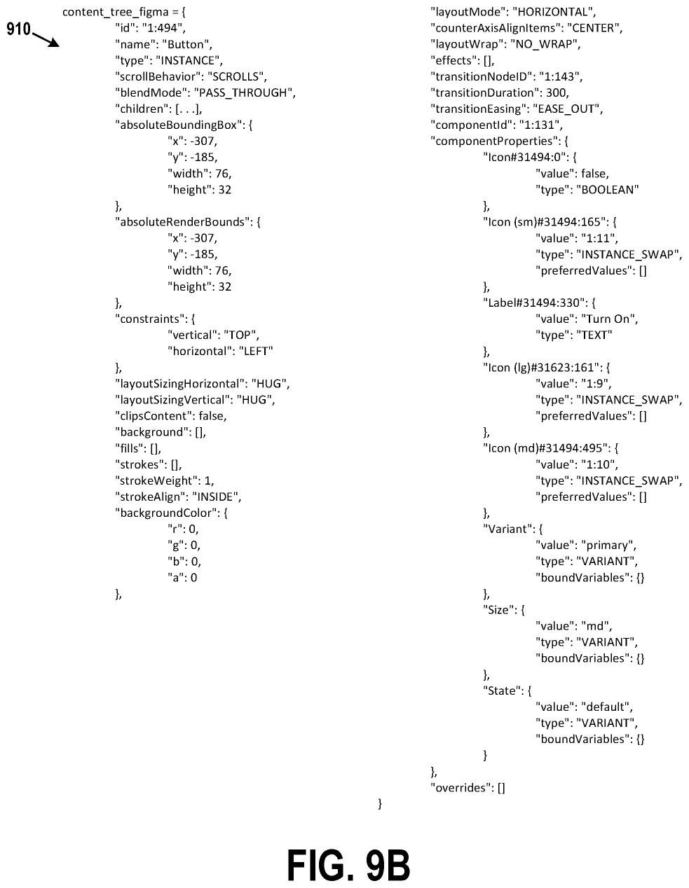

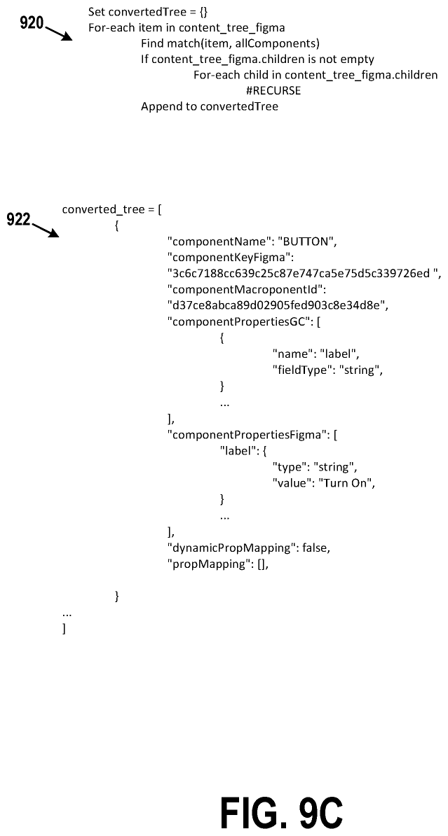

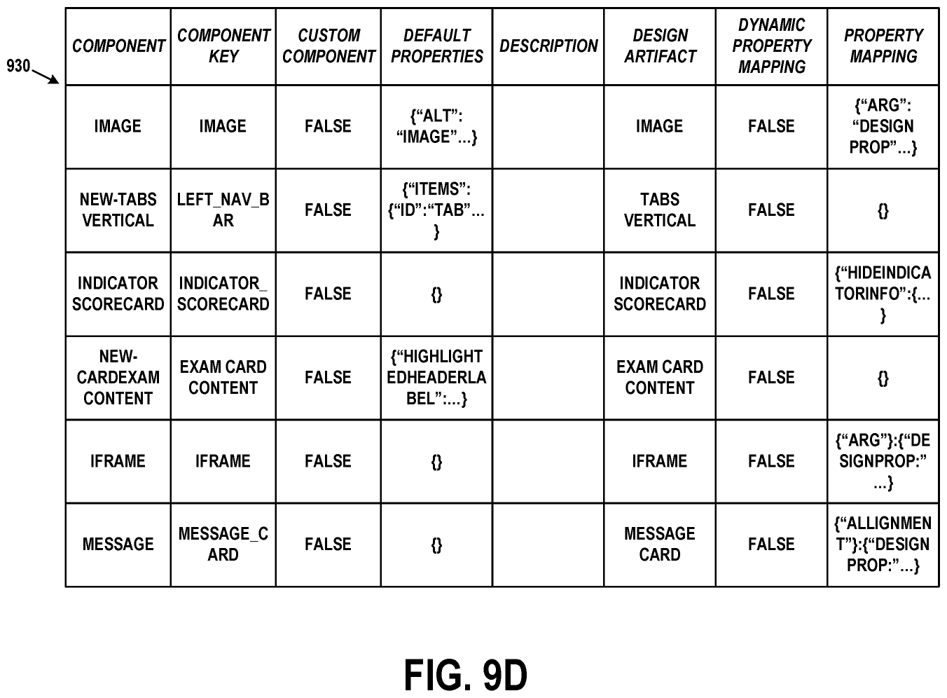

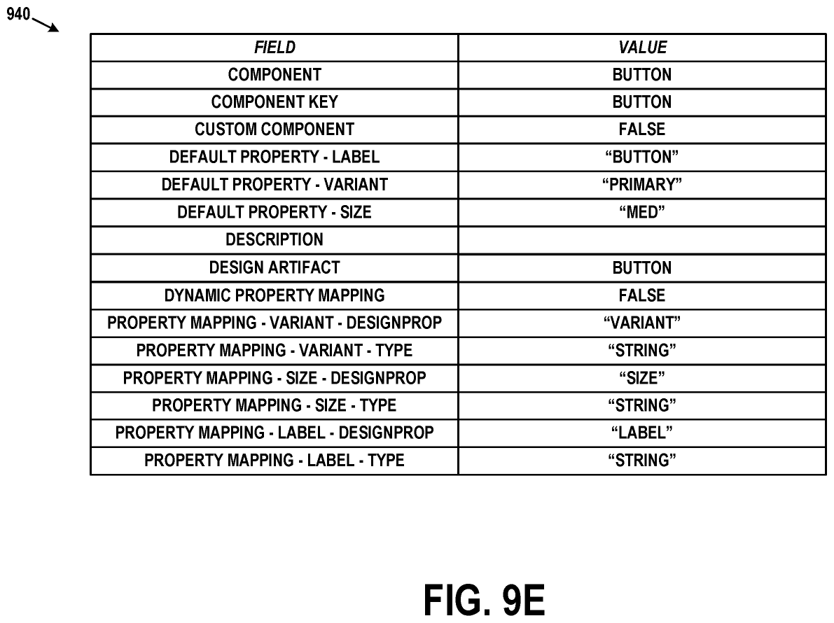

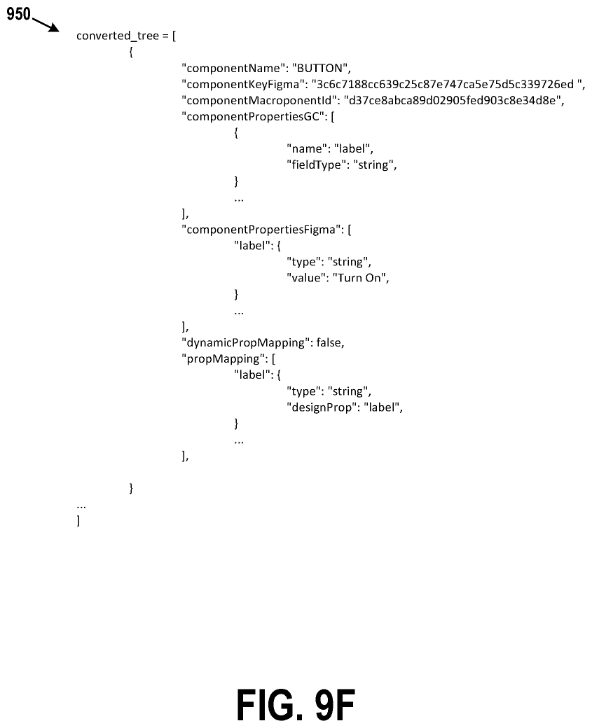

Content tree generator 900 may be configured to receive a GUI design specification of a specific GUI design tool and perform a series of steps based on this specification to ultimately generate and then optionally validate a corresponding GUI design in an implementation-neutral design format (e.g., metadata specifying the design programmatically in a content tree). The implementation-neutral design format may be provided as output from content tree generator 900. These steps will be described in more detail in the discussion of FIGS. 9A-9F. Notably, some steps may interact with LLM service 700 and/or component mapper 800.

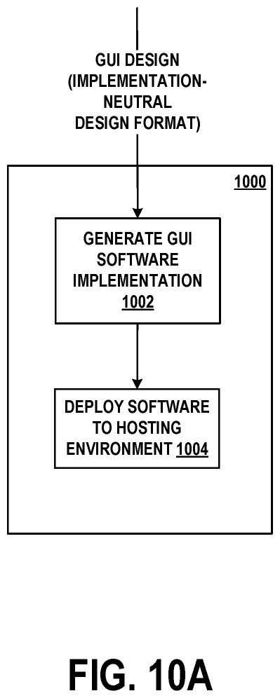

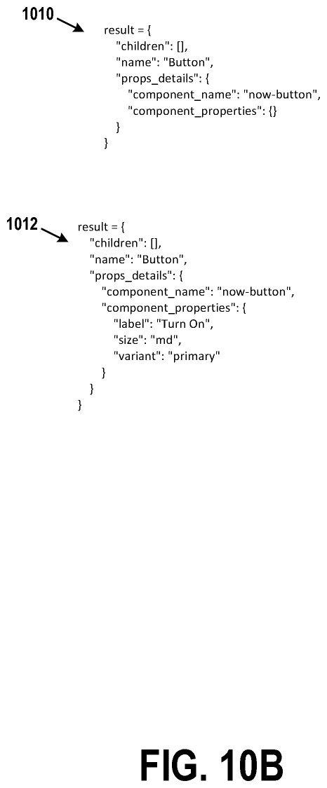

Converter 1000 may take the GUI design in the implementation-neutral design format (e.g., the output of content tree generator 900) and transform it into a GUI software implementation. This implementation-specific design format may be JavaScript/HTML/CSS, ANGULAR®, or REACT®, as just some examples. Converter 1000 will be described in more detail in the discussion of FIG. 10.

In various implementations, at least parts of LLM service 700, component mapper 800, content tree generator 900, and converter 1000 may operate on or be accessible to remote network management platform 320. Some aspects of these software modules may be invoked remotely, such as when LLM service 700 invokes an LLM (described in more detail below).

Also, architecture 600 itself might be remotely invoked, such as by a plugin module of a GUI design tool. In this case, the user of the design tool would select the plugin module from the GUI design tool, causing the plugin module to execute. Then, the user would supply the GUI design specification to the plugin. The plugin module would transmit the GUI design specification to remote network management platform 320 (for example). Remote network management platform 320 would invoke LLM service 700, component mapper 800, content tree generator 900, and converter 1000 on this GUI design specification. Remote network management platform 320 would then deploy the generated GUI software implementation to a hosting environment. Other possibilities exist.

### B. LLM Service

An LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

As noted above, LLM service 700 can be thought of as a “wrapper” or set of APIs around an LLM. This aspect is illustrated by FIG. 7. In this figure, input 710, LLM prompt 716, LLM output 720, and output 724 generally represent data, while select pre-configured prompt template 712, generate LLM prompt 714, and post-processing 722 generally represent processing steps that act on data. LLM provider 718 may be a remotely accessible or local LLM system that can be communicated with by way of an LLM API.

LLM service 700 may receive input 710 from a calling entity. This input may be an input string or prompt from a module of content tree generator 900 or converter 1000, for example, and possibly other contextual information as well (e.g., the type or class of information sought from LLM service 700). Thus, input 710 might be provided to LLM service 700 in the form of a function call such as:
call LLM_API(string, type)

Where string is an input string intended to be used as the basis of an LLM prompt, and type is an optional parameter that provides more information regarding the type of output that is desired.

Notably, input 710 may be referred to as a prompt and can be used as the basis for generation of LLM prompt 716. Thus, unless context suggests otherwise, the term “prompt” generally refers to input provided to LLM service 700 while the term “LLM prompt” generally refers to a query that is used to invoke LLM provider 718.

Post-processing 722 may modify or transform LLM output 720 in various ways, such as modifying words, phrases, or tokens, removing unnecessary whitespace, or otherwise formatting LLM output 720 into output 724. Then, LLM service 700 returns output 724 to the calling entity.

### C. Component Mapper

FIG. 8 depicts component mapper 800. As noted above, it may include a set of associations 818 between representations of design artifacts of a GUI design tool and GUI components. Associations 818 may be in the form of a table, hash map, or database. Associations 818 may include property rules for determining the properties of the GUI components, e.g., based on the properties of their corresponding design artifacts. Thus, given design artifact 810, component mapper 800 may produce a corresponding GUI component 816.

In this figure, design artifact 810, GUI component 816, and associations 818 generally represent data, while find matching GUI component step 812 and populate GUI component properties step 814 generally represent processing steps that act on data. Any of these processing steps may incorporate or rely on pre-processing or post-processing steps that are not shown in FIG. 8.

Component mapper 800 may receive design artifact 810 from one or more steps of content tree generator 900, for example. Design artifact 810 may be in the format of and/or generated by a GUI design tool such as FIGMA®, INVISION®, MIRO®, or an ADOBE® software package. Alternatively, design artifact 810 may be represented in a structured format, such as JSON or XML. In other alternatives, design artifact 810 may be a name of, and indicator of, or a reference to a design artifact and its properties rather than the design artifact itself.

As discussed above, design artifacts could represent buttons, non-editable text labels, text boxes, check boxes, radio buttons, drop-down menus or lists, list boxes with selectable list items, sliders, charts, graphs, panels, progress indicators, menu bars, tool bars, tabbed controls, dialog boxes, scroll bars, image viewers, tooltips, separators, and so on. Each of these types of design artifact may have an artifact name that is unique across all such types. Further, design artifact 810 may have a number of properties. These properties may include one or more of each of: a size, a position, a color, a style, a visibility, a validation rule, a reference to a data binding, and/or a custom event handling routine or script. Each of these properties may have a property name that is unique within the properties of its design artifact.

Find matching GUI component step 812 may search associations 818 for the artifact name of design artifact 810. If present, an entry in associations 818 may also include the GUI component name of a corresponding GUI component of the implementation-neutral design, as well as zero or more property rules. For example, if the artifact name is “button”, then find matching GUI component step 812 may identify the GUI component with the GUI component name “GC_button” as corresponding to design artifact 810. Find matching GUI component step 812 may also obtain a copy of or a reference to rules2 (i.e., a set of zero or more rules that govern how the properties of the GUI component “GC_button” are determined based on the properties of the design artifact “button”).

As an example, suppose that the design artifact “button” has the following tuple of properties: (size=256×64; text=“OK”; bg_color=0,0,0; text_color=255,255,255). This defines a button design artifact that is 256 pixels across and 64 pixels high, contains the text “OK”, has a background color of black, and also has a text color of white. These colors are expressed in red-green-blue (RGB) channels. The property rules (rules2) for this design artifact may specify one-to-one mappings between the properties in this format and JSON used by the implementation-neutral design format of the GUI component. The associated JSON may be:

```
{
  “GC_button”: {
    “dimensions”: “256x64”,
    “text”: “OK”,
    “color”: {
      “r”: 0,
    “g”: 0,
      “b”: 0
    },
    “txtcolor”: {
      “r”: 255,
      “g”: 255,
      “b”: 255
    }
  }
}
```

For example, the property rules may indicate that the design artifact properties “button”, “size”, “bg_color”, and “text_color” are to be converted to the GUI component properties “GC_button”, “dimensions”, “color”, and “txtcolor”, respectively. The property rules may also indicate the shown format for the RGB channel specification (e.g., individual sub-properties for each of the R, G, and B values). Other types of property rules may include a default value for a property. This may be a value to assign to the property if a corresponding property does not exist in design artifact 810 or has an empty or null value in design artifact 810.

Associations 818 could be developed manually or generated by a machine learning model that has been trained on mappings between design artifacts and their corresponding GUI components. Alternatively or additionally, associations 818 could be developed using generative artificial intelligence (AI) trained on the structure and properties of GUI components.

In any event, populate GUI component properties step 814 may fill out the properties of the identified GUI component according to its property rules as set forth in associations 818. The result may be a GUI component that is fully specified. Nonetheless, the GUI component may have more or fewer properties than design artifact 810, and some of these properties may have different values.

Component mapper 800 may provide this populated GUI component, as GUI component 816, to the entity that called component mapper 800 with design artifact 810. Thus, GUI component 816 may be provided as a corresponding GUI component to design artifact 810.

In some embodiments, component mapper 800 may determine mappings from design artifacts to GUI components separately from the mappings of the properties thereof.

In other words, there may be separate sets of associations for each of these functions, and properties may be determined by component mapper 800 or other mechanisms such as those discussed below.

### D. Content Tree Generator

FIG. 9A depicts content tree generator 900. This aspect of overall architecture 600 converts a GUI design specification (e.g., in a format native to FIGMA®, INVISION®, MIRO®, or various ADOBE® GUI design tools) into an implementation-neutral design format. Content tree generator 900 may employ LLM service 700 and component mapper 800 as needed to facilitate conversion of specific design artifacts into GUI components as well as to fill out the properties of the GUI components.

Content tree generator 900 may include several steps as shown in FIG. 9A. These may include traverse GUI design specification step 902, identify GUI components step 904, and populate properties step 906. Notably, identify GUI components step 904 may invoke component mapper 800 and populate properties step 906 may invoke LLM service 700.

Traverse GUI design specification step 902 may involve reading the GUI design format into memory for further processing. An example FIGMA® GUI design specification for two pages of a GUI that has been read into JSON structure 910 is shown in FIG. 9B. The following are examples of what some of the elements of JSON structure 910 represent. The “id” element may be a unique ID for the current node in the content tree for the page. The “componentId” element may be a unique ID representing the current component in its component library within FIGMA®. The “componentProperties” element may be a list of configurable properties for the component, their types and their actual values. These may determine the appearance and content of the component. The “children” element may be nodes present inside the current node. These are typically relevant to frame nodes since child elements of components are usually specific visual elements of the component that are not customizable. The “constraints”, “layoutSizingHorizontal”, “layoutSizing Vertical”, “layoutMode”, “layoutWrap”, and “counterAxisAlignItems” elements may handle alignment, sizing and arrangement of the child elements of the current node. The “strokes”, “strokeWeight”, and “strokeAlign” elements may be border details and any lines that can be rendered within the current component or frame. The “fills”, “background”, and “backgroundColor” elements may be details for the background of the current component or frame. The remaining elements may be specific rendering details for the current node or animation details for presenting the design file.

JSON structure 910 is inherently tree-like, with the content_tree_figma element as root. The nesting of the design artifacts in JSON structure 910 defines the GUI layout and each design artifact has a number of properties. Ellipses (“ . . . ”) are used to indicate where a portion of the GUI design specification has been omitted for purposes of presentation.

Traverse GUI design specification step 902 may perform a tree-based traversal of the GUI design specification. This traversal may be depth-first or breadth-first, for instance. Certain nodes in JSON structure 910 represent design artifacts and their properties as specified by FIGMA®.

As part of the traversal, identify GUI components step 904 recognizes these design artifacts and invokes component mapper 800 to convert them into corresponding GUI components. In FIG. 9C, pseudocode 920 represents a depth-first traversal algorithm for identifying design artifacts in the tree rooted at content_tree_figma in JSON structure 910. As each node representing a design artifact is located, it is appended to JSON structure 922. Particularly, it is appended to a location of the tree defined by the converted_tree element of JSON structure 922 that represents the design artifact's position in the GUI layout. JSON structure 922 is a partial representation of the GUI design, with ellipses (“ . . . ”) used to indicate where a portion has been omitted for purposes of presentation.

As discussed above, component mapper 800 can be invoked with the name of a design artifact or a specification of a design artifact and then return a corresponding GUI component. In some cases, component mapper 800 can also provide at least some of the properties for the corresponding GUI component or a mapping thereof.

Table 930 of FIG. 9D provides a more detailed example of design artifact to GUI component mappings (e.g., a more complete representation of associations 818 for a specific set of mappings). Each row of table 930 identifies a GUI component (e.g., by name as shown in the “Component” column), a component key (e.g., a unique identifier of the GUI component as shown in the “Component Key” column), whether it is a custom GUI component (e.g., as shown in the “Custom Component” column), a set of the GUI component's default properties (e.g., in JSON as shown in the “Default Properties” column), an optional description of the GUI component (e.g., as shown in the “Description” column), the name of a corresponding design artifact (e.g., as shown in the “Design Artifact” column), whether dynamic property mapping is to be used to determine at least some properties of the GUI component (e.g., as shown in the “Dynamic Property Mapping” column), and/or a pre-defined property mapping (e.g., in JSON as shown in the “Property Mapping” column). More or fewer columns may be used in Table 930.

Given a design artifact, identify GUI components step 904 may invoke component mapper 800 with its name. Component mapper 800 may look up the design artifact's name in table 930 (associations 818), searching for matches in the “Design Artifact” column. When a match is found, component mapper 800 may provide, for example, the component key and any default properties of the corresponding GUI component. Then, identify GUI components step 904 may populate JSON structure 922 with one or more JSON elements that represent the corresponding GUI component.

For example, suppose that identify GUI components step 904 invokes component mapper 800 with a design artifact of the type “image”. Component mapper 800 may them determine that this design artifact corresponds to the GUI component name “image” and with the component key of “IMAGE”. Then, a representation of the GUI component and its default properties are returned to identify GUI components step 904 (e.g., in JSON), and identify GUI components step 904 may place this representation into a location in JSON structure 922 that corresponds to the location of the design artifact in JSON structure 910.

While properties can be mapped during identify GUI components step 904, they can also be mapped in populate properties step 906. Regardless, property mapping may occur in a similar fashion as that of component mapping. As an example, FIG. 9E depicts property mapping 940 between a button design artifact and a corresponding button GUI component. The GUI component has default properties of (in JSON): {“label”:“Button”, “variant”:“primary”, “size”:“med”}. The property mapping serves to associate the property names for the design artifact to those of GUI component. In this example, the property names are identical for both (which is not uncommon). Thus, the “label” design artifact property is converted into the “label” GUI component property, the “variant” design artifact property is converted into the “variant” GUI component property, and the “size” design artifact property is converted into the “size” GUI component property. The types for each of these properties are strings, and the values of the respective strings may be converted as well.

FIG. 9E illustrates static property mapping. An optional dynamic property mapping may be indicated by a Boolean value that determines whether LLM service 700 is invoked to generate at least some of the properties of the GUI component. An LLM can be useful in some situations where the properties of a GUI component cannot be easily determined from the properties of its corresponding design artifact. For instance, the GUI component may have required properties for which corresponding properties of the design artifact do not exist.

In such cases, LLM service 700 may be invoked with a specific prompt or may be configured to select a predefined prompt template for this purpose. An example of such a prompt template might be:
Begin. Note only respond in valid JSON. Here is a component with name, ′″+item.componentName+′″, and the source list of properties, ′″+item.componentPropertiesFigma+′″. Each item in the source list of properties contains all relevant details of the particular property. Map each of these properties to the best matching ones from the target list of properties, ′″+item.componentPropertiesGC+′″, which contains the target property names as the key and the value for that property as the value. The result of the mapping should be a JSON object with the keys being the name of the source property and the value being the name of the target property. Make sure to match the data type of the source property with the data type value of the target property. If there is no match, keep the target property as null.

Here, item.componentName is the name of a FIGMA® design artifact, item.componentPropertiesFigma is a list of the properties of this design artifact, and item.componentPropertiesGC is a list of properties of the corresponding GUI component. When filled out, this prompt template can cause LLM service to provide the following example dynamic property mapping for a tooltip design artifact:

```
  {
    “label”: “label”,
    “variant”: “variant”,
    “size”: “size”,
    “disabled”: null,
    “icon”: null,
    “tooltipContent”: null,
    “configAria”: null
}
```

Regardless, JSON structure 950 of FIG. 9F (which builds upon JSON structure 922 in FIG. 9C) depicts a partial representation of the converted_tree element. JSON structure 950 provides an example of how a property mapping might be represented in the implementation-neutral design format produced by content tree generator 900. Notably, a “BUTTON” GUI component is mapped from a FIGMA® design artifact representing a button of a GUI. The GUI component's properties include a “label” represented as a text string (e.g., in the “componentPropertiesGC” element). This is associated with the FIGMAR design artifact's properties of a “label” also represented as a string (e.g., in the componentPropertiesFigma element). The “propMapping” element associates the GUI component with the FIGMA® label. The value of the text string is “Turn On”, which is only represented in the componentPropertiesFigma element for sake of brevity. Nonetheless, other arrangements of JSON and/or other structured representations are possible.

At this point in the process, there is a representation of a GUI in an implementation-neutral design format. This representation includes components and properties mapped and/or generated by the content tree generator 900 based on the GUI design specification.

### E. Converter

As discussed above, converter 1000 may transform the implementation-neutral design format produced by content tree generator 900 into a GUI software implementation. This implementation may take the form of JavaScript/HTML/CSS, ANGULAR®, or REACT®, as just some examples.

Another possible GUI software implementation is the SERVICENOW® Seismic GUI framework. Seismic incorporates a metadata-driven architecture to enhance and streamline the development of software applications, providing a dynamic and flexible method for defining and managing GUI components and their behaviors. Seismic includes a robust architecture for storing and processing the metadata associated with each GUI component. This metadata encompasses a wide range of attributes, including but not limited to component properties, layout configurations, styling details, and interaction rules. By leveraging this metadata, the framework enables a high degree of customization and adaptability.

This permits the GUI components to be defined through metadata rather than through direct code, allowing GUI developers to specify the characteristics and behavior of UI components in a declarative manner. For instance, a GUI developer can define the properties of a button, such as its label, color, and action, through metadata, which the framework then interprets to render the button in the application. Another significant advantage of this metadata-driven approach is the ease of maintenance and scalability it offers. Changes to the GUI, such as modifying a component's appearance or behavior, can be achieved by simply updating the metadata, without the need for extensive code modifications. This results in a more efficient development process, particularly for large-scale applications where consistent GUI components are reused across different parts of the application.

Furthermore, the metadata framework is designed to be dynamic, enabling real-time updates and responsiveness to user interactions. For example, the GUI can automatically adjust its layout or present different options based on user input, all driven by underlying metadata rules. This dynamic behavior enhances the user experience, making the software applications more intuitive and responsive to user needs.

Nonetheless, Seismic is just one possible GUI framework supported by the embodiments herein. As noted, others such as JavaScript/HTML/CSS, ANGULAR®, or REACT® could be used.

FIG. 10A depicts an example implementation of converter 1000. In FIG. 10A, converter 1000 includes generate GUI software implementation step 1002 and deploy software to hosting environment step 1004.

Generate GUI software implementation step 1002 may involve transforming the implementation-neutral design format of a received GUI design into a GUI software implementation. This may involve parsing through the tree-like representation of the GUI design in the implementation-neutral design format and generating, for each GUI component, corresponding code, metadata, and/or configuration information that implements the GUI in a specific GUI framework.

Doing so may involve a two-phase process. First, each GUI component may be converted from the implementation-neutral design format into the GUI software implementation. Second, the properties of each GUI component are converted from the converted from the implementation-neutral design format into the GUI software implementation. This is accomplished while maintaining the GUI layout, which is inherently represented by the tree-like structure of the implementation-neutral design format.

An example outcome of this process for a particular component is shown in FIG. 10B. JSON structure 1010 is a Seismic implementation of a button GUI component (e.g., the button specified in JSON structure 950). Notably the Seismic element “now-button” is identified in the “component_name” element but its properties are undefined in the “component_properties” element. JSON structure 1012 is a representation of JSON structure 1010 where the “component properties” element is filled out with those specified in JSON structure 950. While the process can occur in two phases as noted above (i.e., one for converting GUI components and another for converting their properties), it also could be implemented in a single phase (i.e., converting each of the GUI components and their respective properties before moving on to the next GUI component in the layout).

Deploy software to hosting environment step 1004 may involve transmitting the GUI software implementation to an environment in which the GUI software implementation can be tested or otherwise used. This may involve using the file transfer protocol (FTP), HTTP, or various web-based protocols to facilitate the transfer. For example, the GUI software implementation may be converted to a deployable package (e.g., based on a compressed archive format, such as a ZIP file), pushed to the hosting environment, unpackaged into an appropriate directory structure, and then granted permissions that allow remote access.

Once deployed, GUI software developers can use the GUI, test it, modify it, and so on. New GUI software implementations can be generated as needed from updated GUI design specifications.

In summary and referring back to overall architecture 600 of FIG. 6, a GUI design specification can may be represented in a structured format that provides an arrangement of design artifacts that are used as elements of the GUI design. Such a GUI design specification may be converted into an implementation-neutral design format by using component mappings and possibly natural language processing. The implementation-neutral design format can be parsed and converted on a component-by-component basis into a GUI software implementation (e.g., a combination of JavaScript, HTML, and CSS).

### VIII. Example GUI-to-Design Procedures

Given a GUI software implementation, it can be advantageous to be able to convert that implementation into a GUI design specification. This is the case if the GUI software implementation was developed without a GUI design specification, because having an accurate GUI design specification for the GUI software implementation can facilitate faster and more efficient updates to the GUI design specification as well as the GUI software implementation. For example, a GUI designer may want to make changes to an implemented GUI by using GUI design tools rather than editing the GUI software implementation directly. But even if a GUI design specification exists for a GUI software implementation, the latter may have been revised one or more times during testing and deployment. Thus, it is advantageous to be able to programmatically derive the GUI design specification for an updated GUI software implementation.

The embodiments herein provide a solution to this and possibly other technical problems. Similar to the discussion above, these embodiments are based to some extent on the observation that there can be a one-to-one mapping established between (i) each design artifact of a GUI design specification from a GUI design tool, and (ii) a GUI component that can be placed within a GUI software implementation. There also can be more involved mapping techniques to convert the properties of GUI components into properties of design artifacts.

### A. Overall Architecture

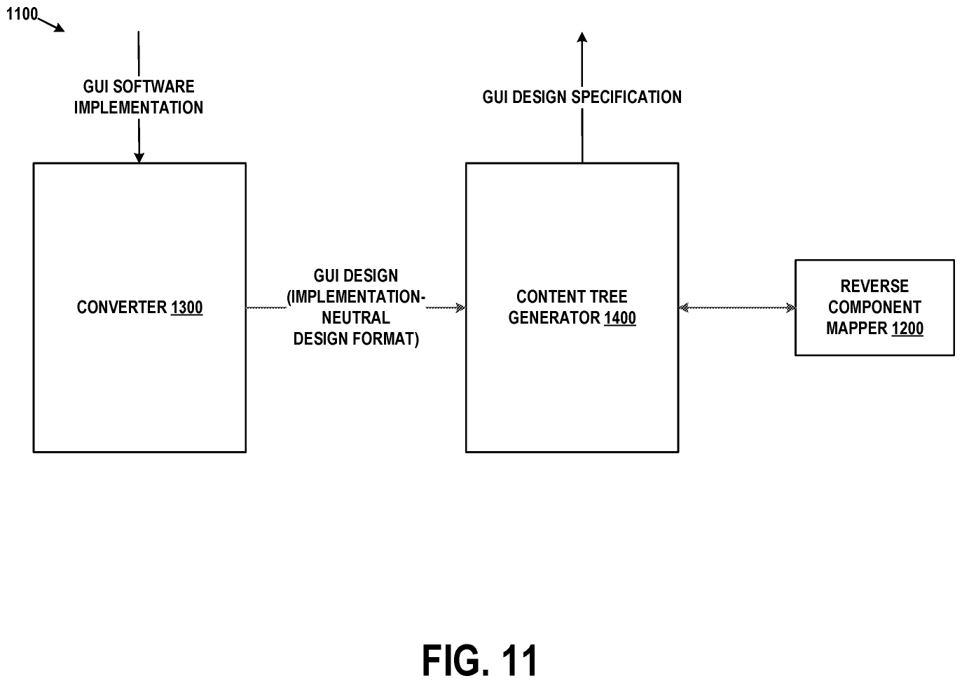

FIG. 11 depicts an overall architecture 1100 for the GUI-to-design process. Overall architecture 1100 includes software modules for reverse component mapper 1200, converter 1300, and content tree generator 1400. Nonetheless, more or fewer parts of overall architecture 1100 may be present. Notably, overall architecture 1100 supports multiple instances of converter 1300, each configured to generate an implementation-neutral design format from a different type of GUI software implementation. Overall architecture 1100 also supports multiple instances of content tree generator 1400, each configured to generate a GUI design specification in accordance with a different GUI design tool.

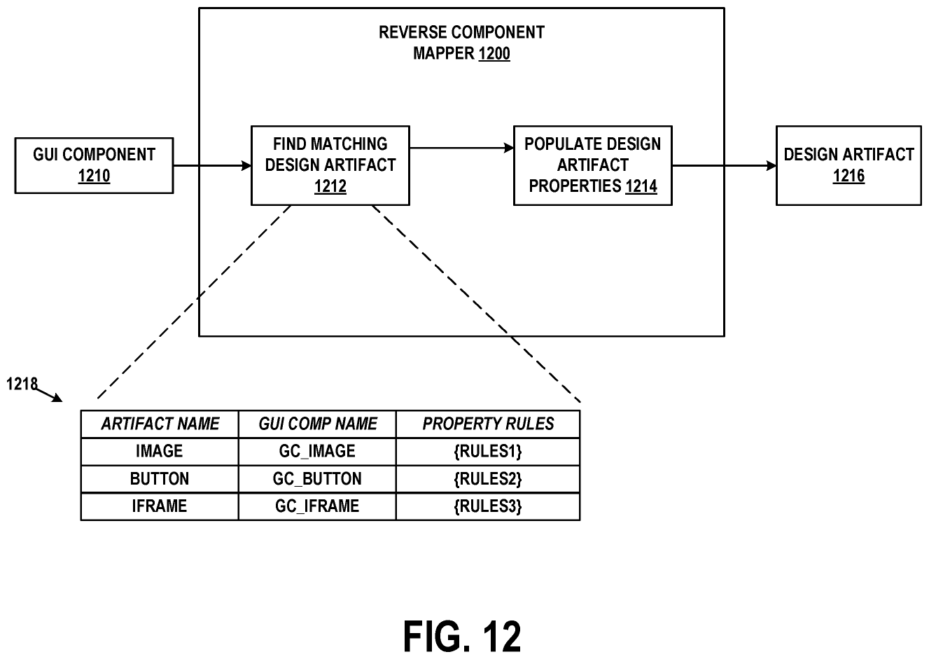

Reverse component mapper 1200 may include a set of associations (e.g., in the form of a table, hash map, or database) between representations of GUI components and design artifacts. The design artifacts may be those supported by a GUI design tool, and the components may be equivalent or similar GUI components supported by the implementation-neutral design format. Given a representation of a GUI component (e.g., a name or identifier thereof), component mapper 1200 can return a representation of an equivalent or similar design artifact (e.g., a name or identifier thereof). The returned representation of the design artifact may include indications of the design artifact's properties (e.g., size, color, position, text font). These properties may be similar or the same to those the associated GUI component. Reverse component mapper 1200 will be described in more detail in the discussion of FIG. 12.

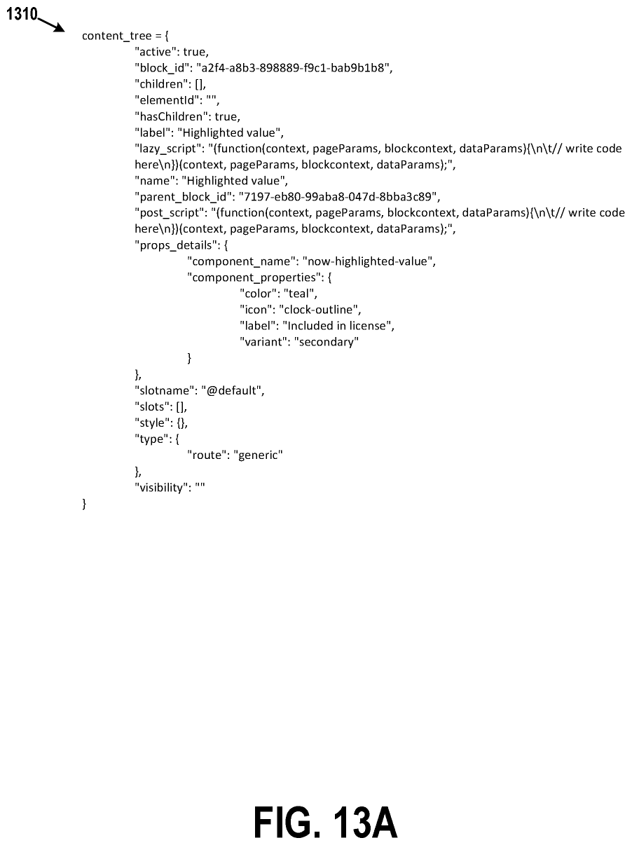

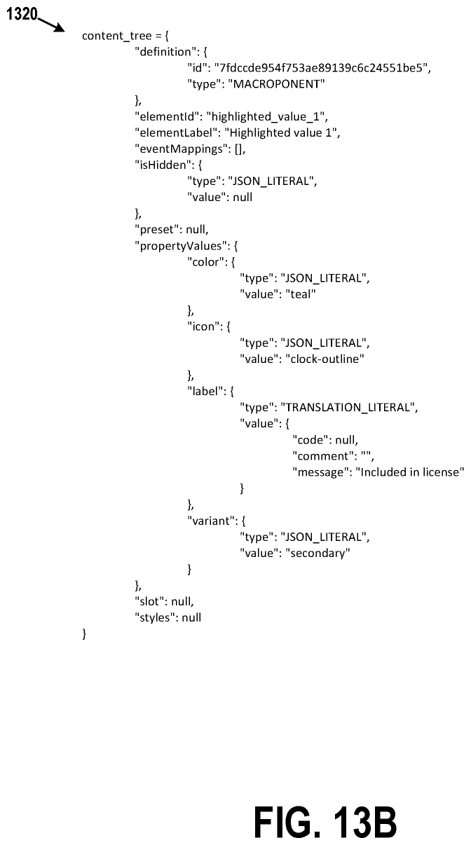

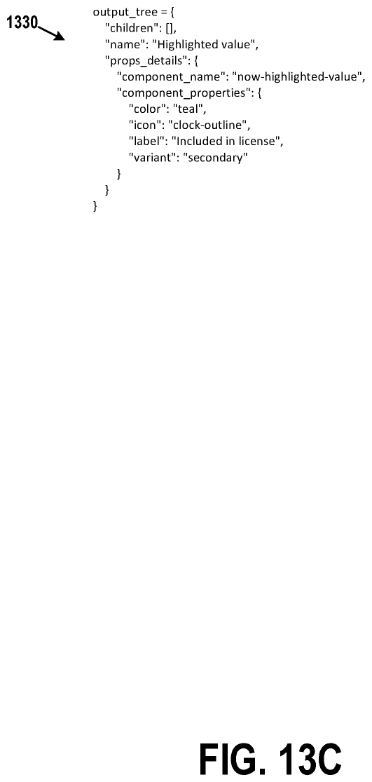

Converter 1300 may take a GUI software implementation and convert it into a representation of a GUI design in an implementation-neutral design format. The GUI software implementation may be in JavaScript/HTML/CSS, ANGULAR®, or REACT®, as just some examples. Converter 1300 will be described in more detail in the discussion of FIGS. 13A, 13B, and 13C.

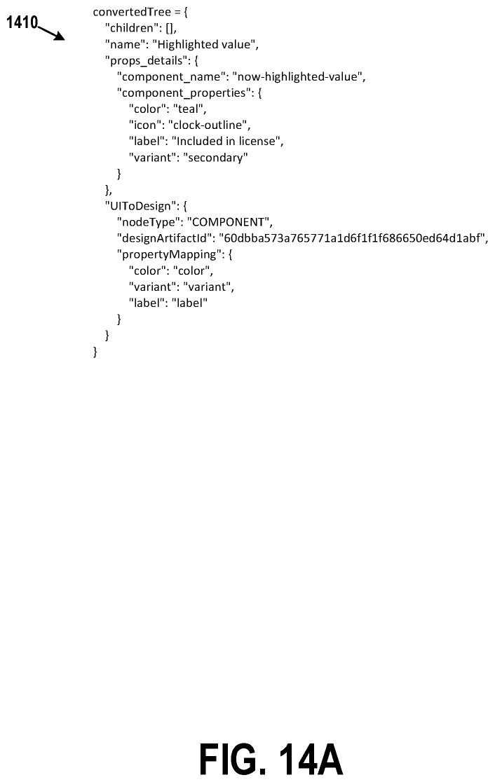

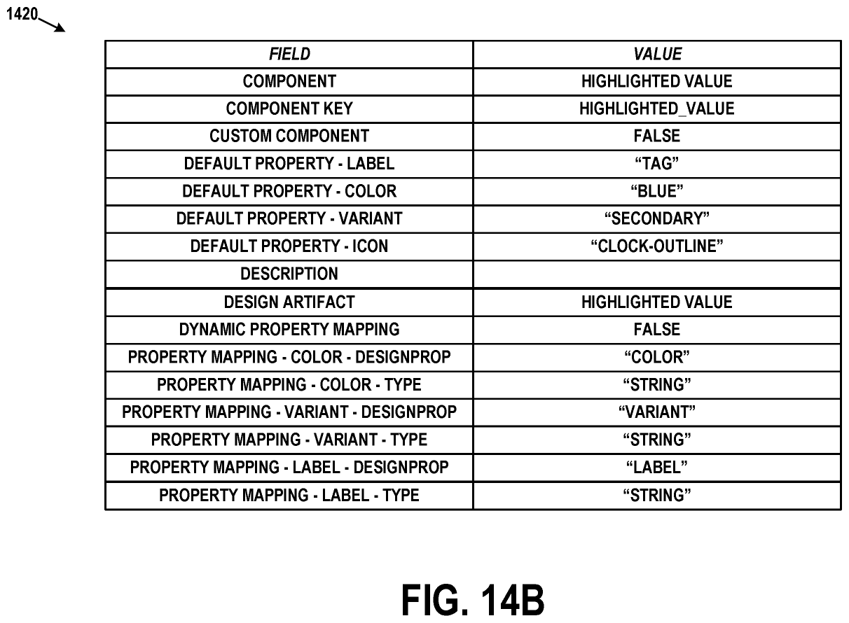

Content tree generator 1400 may be configured to produce a GUI design specification in a format supported by a specific GUI design tool from the implementation-neutral design format. Notably, some steps of this process may interact with reverse component mapper 1200. The implementation-neutral design format may be provided as output from converter 1300. Content tree generator 1400 will be described in more detail in the discussion of FIGS. 14A and 14B.

In various implementations, at least parts of reverse component mapper 1200, converter 1300, and content tree generator 1400 may operate on or be accessible to remote network management platform 320. Also, overall architecture 1100 might be remotely invoked, such as by a plugin module of a GUI design tool. In this case, the user of the GUI design tool would select the plugin module from the GUI design tool, causing the plugin module to execute. Then, the user would supply a network address (e.g., URL or IP address) or other reference to the GUI software implementation to the plugin (e.g., an address of a source code repository). The plugin module would retrieve the GUI design specification and then provide it to remote network management platform 320 (for example). Remote network management platform 320 would invoke reverse component mapper 1200, converter 1300, and content tree generator 1400 on this GUI software implementation. Remote network management platform 320 would then provide the generated GUI design specification to the plugin. The plugin may, in turn, provide the GUI design specification to the GUI design tool. Other possibilities exist.

### B. Reverse Component Mapper

FIG. 12 depicts reverse component mapper 1200. As noted above, it may include a set of associations 1218 between representations of design artifacts of a GUI design tool and GUI components. Associations 1218 may be in the form of a table, hash map, or database. Associations 1218 may include property rules for determining the properties of the design artifacts, e.g., based on the properties of their corresponding GUI components. Thus, given GUI component 1210, reverse component mapper 1200 may produce a corresponding design artifact 1216.

Notably, reverse component mapper 1200 provides a service that is converse to that of component mapper 800. Thus, the description below of reverse component mapper 1200 generally follows the above discussion of component mapper 800, but specifies a converse process.

In FIG. 12, GUI component 1210, design artifact 1216, and associations 1218 generally represent data, while find matching design artifact 1212 and populate design artifact properties 1214 generally represent processing steps that act on data. Any of these processing steps may incorporate or rely on pre-processing or post-processing steps that are not shown in FIG. 12.

Reverse component mapper 1200 may receive GUI component 1210 from one or more steps of content tree generator 1400, for example. GUI component 1210 may be in an implementation-neutral design format. Alternatively, GUI component 1210 may be represented in a structured format, such as JSON or XML. In other alternatives, GUI component 1210 may be a name of, and indicator of, or a reference to a GUI component and its properties rather than the GUI component itself.

As discussed above, GUI component could represent buttons, non-editable text labels, text boxes, check boxes, radio buttons, drop-down menus or lists, list boxes with selectable list items, sliders, charts, graphs, panels, progress indicators, menu bars, tool bars, tabbed controls, dialog boxes, scroll bars, image viewers, tooltips, separators, and so on. Each of these types of GUI component may have a component name that is unique across all such types. Further, GUI component 1210 may have a number of properties. These properties may include one or more of each of: a size, a position, a color, a style, a visibility, a validation rule, a reference to a data binding, and/or a custom event handling routine or script. Each of these properties may have a property name that is unique within the properties of its GUI component.

Find matching design artifact step 1212 may search associations 1218 for the component name of GUI component 1210. If present, an entry in associations 1218 may also include the design artifact name of a corresponding design artifact, as well as zero or more property rules. For example, if the component name is “GC_button”, then find matching design artifact step 1212 may identify the design artifact with the design artifact name “button” as corresponding to GUI component 1210. Find matching design artifact step 1212 may also obtain a copy of or a reference to rules2 (i.e., a set of zero or more rules that govern how the properties of the design artifact “button” are determined based on the properties of the GUI component “GC_button”).

As an example, suppose that the GUI component “GC_button” has the following properties, represented here in JSON:

```
{
  “button”: {
    “dimensions”: “256x64”,
    “text”: “OK”,
    “color”: {
        “r”: 0,
      “g”: 0,
        “b”: 0
    },
    “txtcolor”: {
        “r”: 255,
        “g”: 255,
        “b”: 255
    }
  }
}
```

This defines a button GUI component that is 256 pixels across and 64 pixels high, contains the text “OK”, has a background color of black, and also has a text color of white. These colors are expressed in red-green-blue (RGB) channels. This button GUI component may map to tuple of properties representing those of a corresponding design artifact: (size=256×64; text=“OK”; bg_color=0,0,0; text_color=255,255,255).

The property rules (rules2) for this GUI component may specify one-to-one mappings between the properties in this format and JSON used by the corresponding design artifact. Other types of property rules may include a default value for a property. This may be a value to assign to the property if a corresponding property does not exist in GUI component 1210 or has an empty or null value in GUI component 1210.

Associations 1218 could be developed manually or generated by a machine learning model that has been trained on mappings between GUI components and their corresponding design artifacts. Alternatively or additionally, associations 1218 could be developed using generative AI trained on the structure and properties of design artifacts.

In any event, populate design artifacts properties step 1214 may fill out the properties of the identified design artifact according to its property rules as set forth in association associations 1218. The result may be a design artifact that is fully specified. Nonetheless, the GUI component may have more or fewer properties than GUI component 1210, and some of these properties may have different values.

Reverse component mapper 1200 may provide, as design artifact 1216, this populated design artifact to the entity that called component mapper 1200 with GUI component 1210. Thus, design artifact 1216 may be provided as a corresponding design artifact to GUI component 1210.

In some embodiments, reverse component mapper 1200 may determine mappings from GUI components to design artifacts separately from the mappings of the properties thereof. In other words, there may be separate sets of associations for each of these functions.

### C. Converter

Converter 1300 may be able to convert between various GUI software implementations and an implementation-neutral design format. Supported GUI software implementations may be based on JavaScript/HTML/CSS, ANGULAR®, REACT®, Seismic, or some other technology, and may represent aspects of a GUI in metadata, code, or some combination thereof. For instance, the output of generate GUI software implementation step 1002 (e.g., with examples shown in JSON structures 1010 and 1012) could serve as input to converter 1300.

FIGS. 13A and 13B provide two additional examples of metadata and/or code that could serve as input to converter 1300. Both are in the form of JSON; namely, FIG. 13A provides JSON structure 1310 and FIG. 13B provides JSON structure 1320. Both are representations of GUI components that can be part of a GUI software implementation. The emphasis herein, for sake of simplicity, is on conversion of these relatively small examples to the implementation-neutral design format. JSON structures 1310 and 1320, which are similar to other JSON structures representing GUI software implementations described herein, is inherently tree-like and can be similarly traversed to identify GUI components therein.

Converter 1300 may perform the conversion on web-based GUI software implementations by traversing a document object model (DOM) of the GUI. The DOM is a tree-like representation that defines the layout of a web document, with nodes of the tree corresponding to objects in the document. For example, “document”, “element”, “attribute”, and “text” nodes may be defined where a document node represents the root of the tree, element nodes represent HTML tags, text nodes represent text within elements, and attribute nodes represent the attributes (e.g., properties) of elements. Given this inherent tree-like structure, the GUI layout is discernable. Further, the DOM can be traversed (e.g., depth first or breadth first) and GUI components as well as their properties can be identified based on the elements therein.

The outcome of such a traversal of JSON structure 1310 or JSON structure 1320 is shown in JSON structure 1330 of FIG. 13C. Notably, the GUI component is represented using the component_name and component_properties elements in an implementation-neutral design format similar to what was described above. The traversal of a GUI software implementation may result in a complete GUI design represented in the implementation-neutral design format.

### D. Content Tree Generator

Content tree generator 1400 may operate on such a GUI design represented in an implementation-neutral design format, generating a content tree for the GUI design that is compatible with a specific GUI design tool. The following example first augments the GUI design with component and property mappings, and then converts the GUI design as augmented to a GUI design specification compatible with the GUI design tool FIGMAR. Nonetheless, other GUI design specifications compatible with other GUI design tools may be supported.

Content tree generator 1400 may traverse the GUI design in the implementation-neutral design format and employ reverse component mapper 1200 to generate JSON structure 1410 from JSON structure 1330. Notably, as shown in FIG. 14A, the “UIToDesign” element was added to the “convertedTree” element. The “UIToDesign” element specifies that the component of JSON structure 1410 is of the type “COMPONENT” and also specifies its property mapping (e.g., for the color, variant, and label properties).

As part of its traversal, content tree generator 1400 may recognize GUI components in the GUI design specification and invoke reverse component mapper 1200 to convert them into corresponding design artifacts. As noted above, reverse component mapper 1200 can be invoked with the name of a GUI component or a specification of a GUI component and then return a corresponding design artifact. In some cases, reverse component mapper 1200 can also provide at least some of the properties for the corresponding design artifact or a mapping thereof. In this manner, reverse component mapper 1200 may operate in a converse, but analogous, fashion as that of component mapper 800.

Property mapping of GUI components to design artifacts may also operate in an analogous fashion to what was described above in relation to FIG. 9E. To that point, FIG. 14B depicts property mapping 1420 between a highlighted value GUI component and a corresponding highlighted value design artifact. The design artifact has default properties of (in JSON): {“label”:“Tag”, “color”:“blue”, “variant”:“secondary”, “icon”:“clock-outline”}. The property mapping serves to associate the property names for the GUI component to those of GUI design artifact. In this example, the property names are identical for both (which is not uncommon). Thus, the “label” GUI component property is converted into the “label” design artifact property, the “variant” GUI component property is converted into the “variant” design artifact property, and the “size” GUI component property is converted into the “size” design artifact property. The types for each of these properties are strings, and the values of the respective strings may be converted as well.

Certain GUI design specification formats (such as the one for FIGMA®), may involve additional steps. For instance, a further algorithm may be used perform styles conversion between a GUI component and their FIGMA® equivalent. This algorithm may involve the following steps.

First, creating a design container (frame) using dimensions from the source CSS properties with valid constraints like “min-width”, “max-height”, and so on.

Second, applying layout, alignment and sizing properties to the design artifact. This layout should follow flex-box design for a consistent, direct mapping to the design artifact equivalent of the GUI component. The alignment properties may include “align-items” and “justify-content”. The sizing properties may specify how the container must grow with the content.

Third, converting CSS padding values to a common format for each edge of the GUI component and applying them to the design artifact.

Fourth, applying source container border style, weight, color and radius values to the design artifact.

This covers a significant number of the styles that can be applied to a FIGMA® design artifact. With layouts constructed in this manner, design artifacts can be created with the same API provided by the design application, which can then be slotted into these styled design artifacts.

In summary, such a GUI software implementation can be converted into an implementation-neutral design format. This conversion also take place on a component-by-component basis. The implementation-neutral format may be further converted into a GUI design specification by using reverse component mappings.

### IX. Example Technical Improvements

These embodiments provide technical solutions to technical problems. The technical problems being solved include programmatic conversion of GUI design specifications to GUI software implementations, as well as programmatic conversion of GUI software implementations to GUI design specifications. In practice, this is problematic because there is no known way of doing so at all, much less in a computationally efficient fashion.

In the prior art, GUI design specifications would be used as references for GUI software implementations. This relies on subjective decisions and experiences of software engineers, which leads to wildly varying outcomes from instance to instance. Moreover, once a GUI software implementation is available, there was no way to programmatically convert it back to a GUI design specification. Thus, the prior art techniques did little if anything to address the accurate and consistent generation of a GUI software implementation from a GUI design specification, or the accurate and consistent generation of a GUI design specification from a GUI software implementation.

The embodiments herein overcome these limitations by introducing such programmatic conversion techniques. In this manner, GUI design and implementation can be accomplished faster, as well as in a more accurate and robust fashion. This results in several advantages. First, the generation of both GUI design specifications and GUI software implementations can be performed in a computationally efficient fashion. Most steps of these processes are based on traversal of tree-like text representations (e.g., JSON) and pre-established component mappings. Thus, the processing and memory requirements are not excessive, as resource-intensive LLMs are only used where needed. Second, these embodiments make it easy to maintain the synchronization of GUI design specifications and GUI software implementations—each can be updated rapidly when the other is changed. Third, deviations between design and implementation are virtually eliminated, as each programmatic conversion proceeds in a largely deterministic manner.

Other technical improvements may also flow from these embodiments, and other technical problems may be solved. Thus, this statement of technical improvements is not limiting and instead constitutes examples of advantages that can be realized from the embodiments.

### X. Example Operations

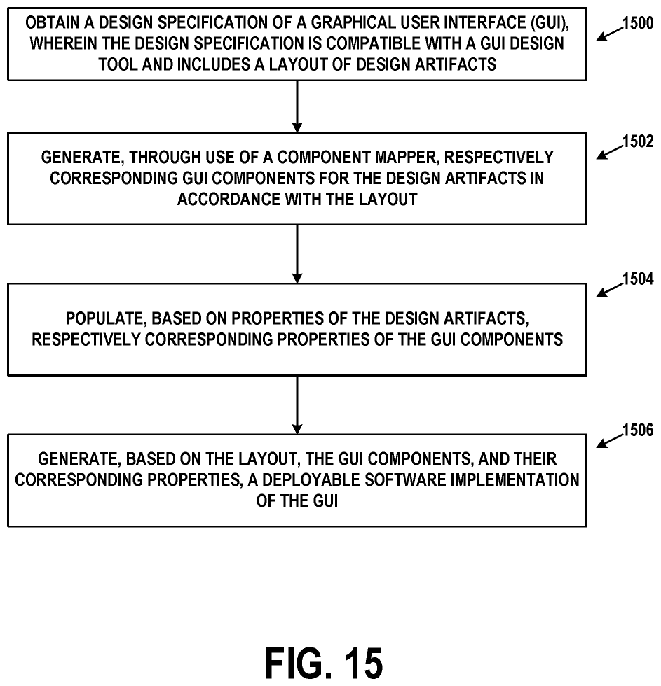

FIG. 15 is a flow chart illustrating an example embodiment. The process illustrated by FIG. 15 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 15 may be simplified by the removal of any one or more of the features shown therein. Further, these embodiments may be combined with features, aspects, and/or implementations of any of the previous figures or otherwise described herein.

Block 1500 may involve obtaining a design specification of a GUI, wherein the design specification is compatible with a GUI design tool and includes a layout of design artifacts.

Block 1502 may involve generating, through use of a component mapper, respectively corresponding GUI components for the design artifacts in accordance with the layout;

Block 1504 may involve populating, based on properties of the design artifacts, respectively corresponding properties of the GUI components.

Block 1506 may involve generating, based on the layout, the GUI components, and their corresponding properties, a deployable software implementation of the GUI.

In some examples, the layout of the design artifacts is arranged in a tree-like fashion, wherein generating the respectively corresponding GUI components for the design artifacts involves a depth-first or breath-first traversal of the layout of the design artifacts.

In some examples, the component mapper associates indications of the design artifacts with predefined specifications of the corresponding GUI components.

In some examples, the component mapper also associates property rules to the indications of the design artifacts, wherein the property rules define how properties of the corresponding GUI components are populated.

In some examples, populating the respectively corresponding properties of the GUI components comprises invoking an NLP model that infers the corresponding properties.

In some examples, the NLP model is a transformer-based large language model that was trained on instances of the properties of the GUI components.

In some examples, invoking the NLP model comprises adding a textual representation of at least some of the properties of the design artifacts to a pre-defined NLP prompt.

In some examples, the design artifacts or the GUI components are specified in JSON metadata or XML metadata as a hierarchy of elements that define the design artifacts or the GUI components and their respective relationships.

In some examples, generating the respectively corresponding GUI components for the design artifacts comprises applying a one-to-one mapping between the GUI components and the design artifacts supported by the GUI design tool.

In some examples, generating the deployable software implementation of the GUI comprises generating, for each of the GUI components and their respectively corresponding properties, metadata or software code that, when interpreted or executed, cause a representation of the GUI to be created.

Some examples may further involve: transmitting, to a server-based hosting environment, the deployable software implementation of the GUI; and arranging the server-based hosting environment so that client devices can remotely interact with the deployable software implementation of the GUI.

In some examples, the GUI components and the corresponding properties of the GUI components are represented in an implementation-neutral design format that is different from formats compatible with the GUI design tool and also different from formats supported by the deployable software implementation of the GUI.

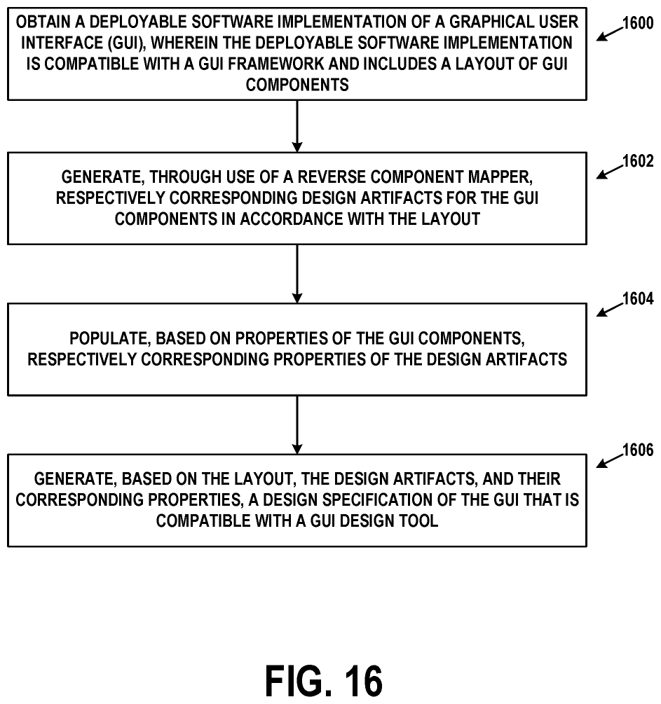

FIG. 16 is a flow chart illustrating an example embodiment. The process illustrated by FIG. 16 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 16 may be simplified by the removal of any one or more of the features shown therein. Further, these embodiments may be combined with features, aspects, and/or implementations of any of the previous figures or otherwise described herein.

Block 1600 may involve obtaining a deployable software implementation of a GUI, wherein the deployable software implementation is compatible with a GUI framework and includes a layout of GUI components.

Block 1602 may involve generating, through use of a reverse component mapper, respectively corresponding design artifacts for the GUI components in accordance with the layout.

Block 1604 may involve populating, based on properties of the GUI components, respectively corresponding properties of the design artifacts.

Block 1606 may involve generating, based on the layout, the design artifacts, and their corresponding properties, a design specification of the GUI that is compatible with a GUI design tool.

In some examples, the layout of GUI components is arranged in a tree-like fashion, wherein generating the respectively corresponding design artifacts for the GUI components involves a depth-first or breath-first traversal of the layout of GUI components.

In some examples, the reverse component mapper associates indications of the GUI components to predefined specifications of the corresponding design artifacts.

In some examples, the reverse component mapper also associates property rules to the indications of the GUI components, wherein the property rules define how properties of the corresponding design artifacts are populated.

In some examples, wherein the design artifacts or the GUI components are specified in JSON metadata or XML metadata as a hierarchy of elements that define the design artifacts or the GUI components and their respective relationships.

In some examples, generating the respectively corresponding design artifacts for the GUI components comprises applying a one-to-one mapping between the design artifacts and GUI components supported by the GUI design tool.

In some examples, generating the design specification of the GUI comprises generating, for each of the design artifacts and their respectively corresponding properties, metadata that, when interpreted, cause the GUI design tool to display a representation of the GUI.

### XI. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a design specification of a graphical user interface (GUI), wherein the design specification is compatible with a GUI design tool and includes a layout of design artifacts;
generating, through use of a component mapper, respectively corresponding GUI components for the design artifacts in accordance with the layout;
populating, based on properties of the design artifacts, respectively corresponding properties of the GUI components; and
generating, based on the layout, the GUI components, and their corresponding properties, a deployable software implementation of the GUI.

2. The method of claim 1, wherein the layout of the design artifacts is arranged in a tree-like fashion, and wherein generating the respectively corresponding GUI components for the design artifacts involves a depth-first or breath-first traversal of the layout of the design artifacts.

3. The method of claim 1, wherein the component mapper associates indications of the design artifacts with predefined specifications of the corresponding GUI components.

4. The method of claim 3, wherein the component mapper also associates property rules to the indications of the design artifacts, wherein the property rules define how properties of the corresponding GUI components are populated.

5. The method of claim 1, wherein populating the respectively corresponding properties of the GUI components comprises invoking a natural language processing (NLP) model that infers the corresponding properties.

6. The method of claim 5, wherein the NLP model is a transformer-based large language model that was trained on instances of the properties of the GUI components.

7. The method of claim 5, wherein invoking the NLP model comprises adding a textual representation of at least some of the properties of the design artifacts to a pre-defined NLP prompt.

8. The method of claim 1, wherein the design artifacts or the GUI components are specified in JavaScript Object Notation (JSON) metadata or extensible Markup Language (XML) metadata as a hierarchy of elements that define the design artifacts or the GUI components and their respective relationships.

9. The method of claim 1, wherein generating the respectively corresponding GUI components for the design artifacts comprises applying a one-to-one mapping between the GUI components and the design artifacts supported by the GUI design tool.

10. The method of claim 1, wherein generating the deployable software implementation of the GUI comprises generating, for each of the GUI components and their respectively corresponding properties, metadata or software code that, when interpreted or executed, cause a representation of the GUI to be created.

11. The method of claim 1, further comprising:
transmitting, to a server-based hosting environment, the deployable software implementation of the GUI; and
arranging the server-based hosting environment so that client devices can remotely interact with the deployable software implementation of the GUI.

12. The method of claim 1, wherein the GUI components and the corresponding properties of the GUI components are represented in an implementation-neutral design format that is different from formats compatible with the GUI design tool and also different from formats supported by the deployable software implementation of the GUI.

13. A method comprising:
obtaining a deployable software implementation of a graphical user interface (GUI), wherein the deployable software implementation is compatible with a GUI framework and includes a layout of GUI components;
generating, through use of a reverse component mapper, respectively corresponding design artifacts for the GUI components in accordance with the layout;
populating, based on properties of the GUI components, respectively corresponding properties of the design artifacts; and
generating, based on the layout, the design artifacts, and their corresponding properties, a design specification of the GUI that is compatible with a GUI design tool.

14. The method of claim 13, wherein the layout of GUI components is arranged in a tree-like fashion, and wherein generating the respectively corresponding design artifacts for the GUI components involves a depth-first or breath-first traversal of the layout of GUI components.

15. The method of claim 13, wherein the reverse component mapper associates indications of the GUI components to predefined specifications of the corresponding design artifacts.

16. The method of claim 15, wherein the reverse component mapper also associates property rules to the indications of the GUI components, wherein the property rules define how properties of the corresponding design artifacts are populated.

17. The method of claim 13, wherein the design artifacts or the GUI components are specified in JavaScript Object Notation (JSON) metadata or extensible Markup Language (XML) metadata as a hierarchy of elements that define the design artifacts or the GUI components and their respective relationships.

18. The method of claim 13, wherein generating the respectively corresponding design artifacts for the GUI components comprises applying a one-to-one mapping between the design artifacts and GUI components supported by the GUI design tool.

19. The method of claim 13, wherein generating the design specification of the GUI comprises generating, for each of the design artifacts and their respectively corresponding properties, metadata that, when interpreted, cause the GUI design tool to display a representation of the GUI.

20. A non-transitory computer-readable medium, having stored thereon program instructions that, upon execution by a computing system, cause the computing system to perform operations comprising:
obtaining a design specification of a graphical user interface (GUI), wherein the design specification is compatible with a GUI design tool and includes a layout of design artifacts;
generating, through use of a component mapper, respectively corresponding GUI components for the design artifacts in accordance with the layout;
populating, based on properties of the design artifacts, respectively corresponding properties of the GUI components; and
generating, based on the layout, the GUI components, and their corresponding properties, a deployable software implementation of the GUI.
